(19) United States
(12) Patent Application Publication
(10) Pub. No.: US 2009/0116344 A1
(43) Pub. Date: May 7, 2009

(54) INFORMATION RECORDING METHOD, INFORMATION RECORDING MEDIUM, AND INFORMATION RECORDING APPARATUS

(76) Inventors: Eiko Hibino, Kanagawa (JP); Yujiro Kaneko, Tokyo (JP); Hiroko Ohkura, Kanagawa (JP)

Correspondence Address: COOPER & DUNHAM, LLP, 30 Rockefeller Plaza, 20th Floor, NEW YORK, NY, 10112, US

(21) Appl. No.: 12/092,293

(22) PCT Filed: Aug. 14, 2007
(86) PCT No.: PCT/JP2007/066081

§ 371 Date: May 1, 2008

(30) Foreign Application Priority Data
Sep. 14, 2006 (JP) 2006 250050
Jun. 11, 2007 (JP) 2007 154295

(51) Int. Cl. G11B 7/00

(52) U.S. Cl. 369/44.13; 369/47.5; G9B/7

(57) ABSTRACT

An information recording method recording information on an information recording medium in the form of a recording mark having a time-length nT by irradiating optical beam pulses thereto according to a recording strategy, the recording strategy comprises the steps of forming the recording mark on the recording medium by controlling a power of the optical beam pulses to one of ternary values Pw, Pb and Pe (Pw>Pe>Pb) and irradiating a heating pulse having a power set to Pw, and a cooling pulse having a power set to Pb, upon the information recording medium alternately; and forming a space on the recording medium subsequent to the recording mark by irradiating the optical beam pulse with the power Pe, the recording strategy increasing the number of said heating pulses by one each time the time-length of the recording mark is increased by 2T, the recording strategy setting a heat pulse starting time sTtop and a heat pulse termination time eTtop for a first heating pulse, when forming a recording mark of a time-length of at least 2T, individually at least in the case of forming a space-length of 2T and the case in which there is formed a space-length of 3T or more, before or after the currently formed recording mark.

### TECHNICAL FIELD

The present invention generally relates to information recording technology and more particularly to a large-capacity information recording medium for recording, and information recording method and information recording apparatus suitable for use of such a large-capacity information recording medium.

### BACKGROUND ART

With progress of digital information processing technology and multimedia technology, there is a demand for a recording medium capable of recording and reproducing information with increased storage capacity and improved speed while maintaining compatibility for reproducing with regard to conventional playback-only recording media such as DVD-ROM or CD-ROM. Particularly, the recordable optical disk of the format of DVD-R, DVD-RW, DVD+R, DVD+RW, CD-R, CD-RW, or the like, has wide versatility and easy to use, and the demand thereof is expanding.

In these days, in order to achieve further increased storage capacity, new information recording technology of new format and specification, such as Blu-ray Disk or HD DVD that uses a blue laser diode of the wavelength of 405 nm, has come to practical use with regard to the recording medium of playback-only type, recordable type, and rewritable type.

With these large-capacity information recording media, however, it takes a long time for recording, and thus, there is a stringent demand for the recording medium capable of achieving recording with high speed.

Non-Patent References 1 and 2 describe the recording method of the 1-2× recording mode used with the BD-RE specification and DB-R specification.

### DISCLOSURE OF THE INVENTION

FIGS. 1-3 show the outline of recording operation in an information recording medium of the Blu-ray Disc specification described in Non-Patent Reference 2.

Referring to FIGS. 1-3, the technology of Non-Patent Reference 2 controls a laser beam power into quaternary levels of Pw, Ps, Psw and Pc, and recording mark is formed by heating a recording layer on the recording medium so as to induce therein a change of state such as melting.

On the other hand, when the power of Pw is irradiated continuously, there is caused excessive temperature rise in the recording medium and normal recording mark formation is obstructed. In order to avoid this problem, it is practiced in the art to turn the laser beam of the power Pw on and off to form laser beam pulses.

In the example of FIG. 1, there occurs increase in the mark length by 1 T each time the number of the heating pulse is increased by one. Thus, N−1 heating pulses are used for forming the recording mark of the mark length of 1 T. The recording process of FIG. 1 is called (N−1) recording strategy.

FIG. 2 shows the example of so-called N/2 recording strategy, in which the mark length is increased by 2 T each time the number of the heating pulse is increased by one and recording of mark length NT is conducted by using N/2 heating pulses.

In the case of conducting high-speed recording, it is generally necessary to decrease the period of reference clock, while decrease of the period of reference clock T leads to the problem of difficulty of controlling the laser optical emission for each time interval T. Thus, at the time of high-speed recording, the recording strategy that allows use of long pulse period, as in the case of the N/2 recording strategy, is preferred.

Further, in the case of conducting recoding repeatedly while using a phase change recording material for the recording layer as in the case of the BD-RE format, it is practiced in the art to cause melting in the recording layer with a laser beam power Pw as shown in FIGS. 1 and 2 and subsequently quenching by changing the laser beam power to Psw having a near zero value, such that there is formed an amorphous recording mark. With this recording strategy, there is a tendency of occurrence of recrystallization particularly in the case where cooling time is short, and there is a tendency that the amorphous recording mark of sufficient size is not formed. This is also the reason that the N/2 recording strategy capable of securing sufficient mark length is used in the high-speed recording.

In the case of the BD-R format and BD-RE format, recording is made with the mark length of 2 T-9 T, wherein there is a need, when the N/2 recording strategy is used with such recording format, to write the marks of different lengths by the same number of the heating pulses, as in the case of writing 2 T and 3 T marks with one heating pulse, 4 T and 5 T marks with two heating pulses, 6 T and 7 T marks with three heating pulses, 8 T and 9 T marks with four heating pulses, and the like.

When writing the marks of different lengths with the same number of the pulses, it is generally practiced in the art to change the irradiation starting time of the first heating pulse or the pulse width thereof, or to change the irradiation time of the last heating pulse or the pulse width thereof, or to change the pulse width of the final, cooling pulse.

In the 1-2× recording mode of the BD-R and BD-RE format, in particular, it is practiced in the art, when n is an integer equal to or larger than four, to write the marks of different lengths by changing the parameters dTtop and Ttop, which determine the starting time and the width of the first heating pulse, the parameter Tlp that determines the width of the final heating pulse, and the parameter dTs that determines the width of the final cooling pulse, between the case in which n is an odd number and the case in which n is an even number, and further delaying the starting time of the multiple pulses formed between the first heating pulse and the last heating pulse with the timing of T/2 and by advancing the starting time of the final heating pulse with the timing of T/2. Further, in the case of the mark length of 2 T and 3 T, the parameters dTtop, Ttop and dTs are determined individually rather than the according to the criteria of whether the number n is an even number or odd number.

FIG. 3 is an example of setting the recording strategy that takes into consideration the effect of inter symbol interference.

Meanwhile, when conducting high-density recording as in the case of Blu-ray Disc, there is a case that the location of the mark edge is displaced as a result of the inter symbol interference.

For example, when irradiation of the first heating pulse is started with the same timing for the case of forming a recording mark after a short space as in the example of the 2 T or 3 T mark and for case of forming a recording mark after a long space as in the example of the 5 T or 6 T mark, there arises a problem that the temperature of the recording medium is increased excessively as a result of the remnant heat of the previous recording mark formation.

In order to avoid this problem, it is practiced in the BD-R format and BD-RE format to set the parameters dTtop and Ttop, which determine the irradiation starting time of the first heating pulse and the width thereof, in four different cases according to the space lengths of 2 T, 3 T, 4 T and 5 T or larger, before formation of the recording mark.

This, however is applied only for the case of the N−1 strategy.

For the method of high-speed recording upon a high-density recording medium, there are various proposals in addition to the recording method of the foregoing BD-R or BD-RE format. For example, Patent Reference 1 discloses an effective method for determining the pulse irradiation timing and irradiation time and the method for irradiating the heating pulse in stepwise manner.

On the other hand, Patent References 2-4 discloses the technology that takes into consideration the inter symbol interference, by controlling the irradiation starting time of the first heating pulse based on the space length before the mark and further controlling the irradiation termination time of the final heating pulse based on the space length immediately after the mark formation.

With Patent Reference 2, adjustment is made for irradiation starting time of the heating pulse, or for the parameter dTtop in the designation of FIG. 3 corresponding to a Blu-ray Disc, according to the space length immediately before the recording mark. Here, the use of a single pulse is assumed for the formation of the recording mark.

With Patent Reference 3, adjustment is made for the irradiation starting time of the first cooling pulse immediately after the first heating pulse, or the width Ttop of the first heating pulse in the designation of FIG. 3, according to the previous space length. Further, the termination time of the final cooling pulse, which follows immediately the final heating pulse, or the parameter dTs in the designation of FIG. 3, is adjusted according to the space length immediately after the recording mark. While there is no particular description with regard to the pulse period, the reference anticipates the use of multiple pulses of the period of 1 T.

With Patent Reference 4, adjustment is made for irradiation starting time of the heating pulse, or for the parameter dTtop, according to the space length immediately before the recording mark. Further, the termination time of the final cooling pulse, or the parameter dTs in the designation of FIG. 3, is adjusted according to the space length immediately after the recording mark. In this case, too, the use of multiple pulses of the period of 1 T is anticipated although there is no indication for the pulse period.

The foregoing is the outline of the 1-2× recording mode of the Blu-ray Disc technology.

Meanwhile, with Blu-ray Disc technology, the recording medium has a very large storage capacity such as the capacity of 25 GB in the case of using a single recording layer or the capacity of 50 GB for the case of using two recording layers, and thus, there is needed a correspondingly long recording time for making recording of information. Thus, there is a demand for further high speed of recording.

The inventor of the present invention has made investigation about high speed recording in the Blu-ray Disc technology for the case of the 4× recording speed (19.68 m/s) and discovered that no satisfactory recording characteristics is attained within the parameter range used in the 1-2× recording mode of the recording strategy for the Blu-ray Disc as explained before. In the case of the (N−1) recording strategy, in particular, the degree of modulation remains small even when various parameters such as the power, irradiation time, line width, and the like, are adjusted for the pulses. Further, it was not possible to reduce the jitter.

It is believed that this is caused because there is induced recrystallization in the recording mark, which should be formed by an amorphous phase, in view of the fact that it is not possible to irradiate the cooling pulse of sufficient length as explained before. Thus, it is not possible to form an amorphous mark of sufficient size.

Further, the inventor of the present invention has investigated the possibility of making recording with the N/2 recording strategy. However, it was discovered that, while it is possible to secure sufficient degree of modulation with this approach, it is not possible to suppress jitter satisfactorily with this method. Further, attempt has been made to irradiate the heating pulses in the stepwise manner as disclosed in Patent Reference 1 in the N/2 recording strategy, but no satisfactory recording characteristics was attained in the quadruple speed (4×) recording mode of Blu-ray Disc.

Thus, it is the object of the present invention to attain high-speed recording while using a large storage capacity medium, and for this purpose, the present invention provides an information recording method, information recording medium and information recording apparatus capable of attaining excellent recording characteristics even in the case of making high speed recording such as quadruple speed (19.68 m/s) recording mode upon a high density medium such as a Blu-ray disc.

Patent Reference 1 Japanese Laid-Open Patent Application 2005-4800

Patent Reference 2 Japanese Patent Publication 6-64741

Patent Reference 3 Japanese Patent 3138610

Patent Reference 4 Japanese Patent 3762907

Non-Patent Reference 1 White paper Blu-ray Disc Format 1.A Physical Format Specifications for BD-RE, 2nd Edition, February 2006 (online) <http://www.blu-raydisc.com/Section-13470/Section-13628/Index.html>

Non-Patent Reference 2 White paper Blu-ray Disc Recordable Format Part 1 Physical Format Specifications, February 2006 (online) <http://www.blu-raydisc.com/Section-13470/Section-13628/Index.html>

In a first aspect, the present invention provides an information recording method recording information on an information recording medium in the form of a recording mark having a time-length of nT (T: fundamental clock period, n being a natural number of 2 or larger) by irradiating optical beam pulses thereto according to a recording strategy, said recording strategy comprising the steps of: forming said recording mark on said recording medium by controlling a power of said optical beam pulses to one of at least ternary values Pw, Pb and Pe (Pw>Pe>Pb), and irradiating a heating pulse, in which said power of said optical beam pulse is set to said power Pw, and a cooling pulse, in which said power of said optical beam pulse is set to said power Pb, upon said information recording medium alternately; and forming a space on said recording medium subsequent to said recording mark by irradiating said optical beam pulse with said power Pe, said recording strategy increasing the number of said heating pulses by one each time said time-length of said recording mark is increased by 2 T, said recording strategy setting a heat pulse starting time sTtop and a heat pulse termination time eTtop for a first heating pulse, when forming a recording mark of a time-length of at least 2 T, individually at least in each of the case of forming a space-length of 2 T and the case in which there is formed a space-length of 3 T or more, before or after said currently formed recording mark.

In another aspect, the present invention provides an information recording medium for recording with information, when irradiated with optical beam pulses, in the form of a recording mark having a time-length of nT (T: fundamental clock period, n being a natural number of 2 or more), said information recording medium being pre-formatted according to a recording strategy in which recording is made by controlling a power of said optical beam pulses to one of at least ternary values of Pw, Pb and Pe (Pw>Pe>Pb) and irradiating a heating pulse, in which said power of said optical beam pulse is set to said power Pw, and a cooling pulse, in which said power of said optical beam pulse is set to said power Pb, upon said information recording medium alternately; and forming a space on said recording medium subsequent to said recording mark by irradiating said optical beam pulse with said power Pe, said recording strategy increasing the number of said heating pulses by one each time said time-length of said recording mark is increased by 2 T, said recording strategy being used when forming a recording mark of a time-length of at least 2 T and setting a heat pulse starting time sTtop for a first heating pulse and a heat pulse termination time eTtop for said first heating pulse individually at least in the case of forming a space-length of 2 T and the case in which there is formed a space-length of 3 T or more, before or after said currently formed recording mark.

Further, in another aspect, the present invention provides an information recording apparatus for recording information on an information recording medium by irradiating thereto optical beam pulses in the form of a recording mark having a time-length of nT (T: fundamental clock period, n being a natural number of 2 or more), said information recording apparatus comprising: an optical source for forming said optical beam pulses; a driving system for driving said optical source; and an optical emission controlling apparatus set with a recording strategy determining optical emission waveform, said optical emission controlling apparatus controlling said driving system according to said recording strategy, said recording strategy forming said recording mark on said recording medium by controlling a power of said optical beam pulses to one of at least ternary values Pw, Pb and Pe (Pw>Pe>Pb) and irradiating a heating pulse, in which said power of said optical beam pulse is set to said power Pw, and a cooling pulse, in which said power of said optical beam pulse is set to said power Pb, upon said information recording medium alternately; and forming a space on said recording medium subsequent to said recording mark by irradiating said optical beam pulse with said power Pe, said recording strategy increasing the number of said heating pulse by one each time said time-length of said recording mark is increased by 2 T, said recording strategy setting a heat pulse starting time sTtop for a first heating pulse and a heat pulse termination time eTtop for said first heating pulse, when forming a recording mark of a time-length of at least 2 T, individually at least in the case of forming a space-length of 2 T and the case in which there is formed a space-length of 3 T or more, before or after said currently formed recording mark.

According to the present invention, the problem of deterioration of recording mark (edge shift) caused by inter symbol interference is reduced, and it becomes possible to obtain excellent recording characteristics even when high-density recording is conducted by using blue laser diode.

### BRIEF DESCRIPTION OF THE DRAWINGS

FIG. 1 is a diagram showing a (N−1) recording strategy according to a related art of the present invention;

FIG. 2 is a diagram showing an N/2 recording strategy according to a related art of the present invention;

FIG. 3 is a diagram showing an example of adaptive control used in the recording mark formation of the (N−1) recording strategy according to the related art of the present invention;

FIGS. 4A and 4B are diagrams explaining the problems addressed by the present invention;

FIG. 5 is a cross-sectional diagram showing the construction of a recording medium according to an embodiment of the present invention;

FIG. 6 is a cross-sectional diagram showing the construction of a recording apparatus according to an embodiment of the present invention;

FIG. 7 is a diagram showing the definition of various parameters used with the present invention;

FIG. 8 is a diagram showing the effect of the present invention obtained for an embodiment in comparison with a comparative example;

FIG. 9 is another diagram showing the effect of the present invention obtained for an embodiment in comparison with a comparative example;

FIG. 10 is a further diagram showing the effect of the present invention obtained for an embodiment in comparison with a comparative example;

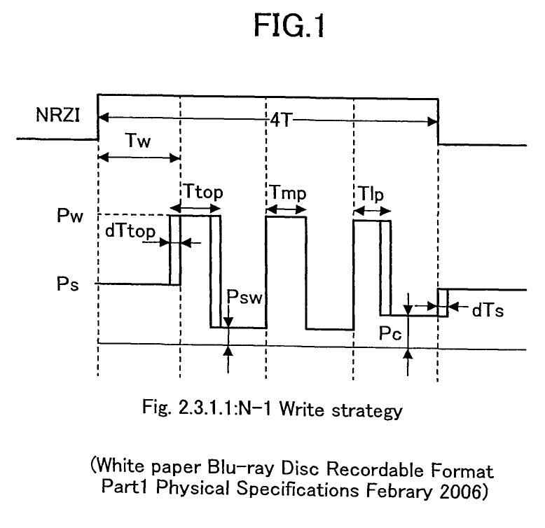

### BEST MODE FOR IMPLEMENTING THE INVENTION

### Principle

The inventor of the present invention has made a discovery, in the investigation that constitutes the foundation of the present invention of improving the recording characteristics while using various N/2 recording strategies in the quadruple speed (4×) mode of Blu-ray Disc, that there occurs an increase of jitter particularly in the 2 T mark.

Thus, the inventor has made intensive investigation about the reason why this increase of jitter appears particularly significant in the case of the 2 T recording mark formed in the quadruple speed (4×) mode, and it was discovered that this problem has been caused as a result of the inter symbol interference.

In more detail, the mark 2 T is the shortest mark having only the length of 0.15 μm, and thus, there occurs decrease of pulse irradiation interval when the mark 2 T is written repeatedly in high-speed wiring mode as in the case of the quadruple speed (4×) mode.

It should be noted that the recording medium suitable for the N/2 recording strategy is a medium designed such that mark formation is controlled effectively when sufficient cooling by the cooling pulses is provided. For the phase change material used for the recording layer for repeated recording, there are used two kinds of materials, the one being a Sb-base material containing Sb as the major component such as the material of the Ag—In—Sb—Te system, the other being a Te-base material containing Te as the major component, such as the material of the system of Ge₂Sb₂ Te₅. In the case of the Sb-base material, crystallization proceeds primarily by crystal growth, while in the case of the Te-base material, crystallization proceeds primarily by nucleation. Generally, crystallization proceeds in two step process of nucleation and crystal growth, wherein the crystal growth process tends to occur at higher temperatures than nucleation process.

Further, between these materials, there is a difference of thermal conductivity, and it should be noted that a Sb-based material shows higher thermal conductivity as compared with the Te-based material. Because of such difference of crystallization mechanism and thermal conductivity, the optimum strategy pattern is different between these materials.

Generally, the pattern of (N−1) recording strategy can be applied to any of the material systems as long as low-speed writing is conducted as in the case of 1× speed of Blu-ray Disc.

On the other hand, in the case of slightly fast speed recording, as in the case of the double-speed writing of Blu-ray Disc, the effect thermal interference caused by the inter symbol interference appears more significantly when using the Te-base material in view of the fact that a Te-base material has a smaller thermal conductivity and hence less efficient for heat dissipation and further in view of the fact that crystallization with nucleation is predominant, and thus, there is a tendency that the recording mark experiences large influence even when there is a thermal interference of relatively low temperature. Thus, a recording strategy shown in FIG. 3 is applied, in which it should be noted that the effect of inter symbol interference is taken into consideration in the recording strategy of FIG. 3.

On the other hand, with the material of the Sb-base system, the effect of inter symbol interference is less significant because of large thermal conductivity. Further, because crystal growth is the predominant crystal growth mechanism, influence on the mark shape does not become significant unless thermal interference is caused at high temperature. Thus, it has been accepted in the art that excellent recording should be possible without taking into consideration the effect of inter symbol interference, as long as the material of the Sb system is used.

Thus, in the case of recordable DVD apparatus, for example, inter symbol interference is taken into consideration for the recording strategy of DVD-RAM that uses a Te-based material, by using a pattern somewhat similar to the (N−1) recording strategy in that it is formed of multiple pulses of 1 T period, while in the case of the format of DVD+RW or DVD-RW that uses a Sb-based material, no inter symbol interference is taken into consideration although it uses a pattern similar to the (N+1) recording strategy and thus formed of multiple pulses of 1 T period.

On the other hand, in the case of conducting high-speed writing with the format of DVD+RW or DVD-RW that uses the Sb-base material, a pattern somewhat similar to the (N/2) recording strategy and thus formed of multiple pulses of 2 T period is used. It should be noted that the use of the (N/2) recording strategy is effective for avoiding the problem of decrease of size of the amorphous mark caused by recrystallization due to insufficient cooling time in the case of conducting high-speed writing with 1 T period. In addition, there arises difficulty in controlling the optical pulse emission with 1 T period in high-speed writing.

In the DVD-RAM that uses the Te-based material, a pattern called “castle pattern” similar to a single pulse pattern except that the power is increased at the front edge and rear edge is used at the time of conducting high-speed writing. Thus, the pattern of the (N/2) recording strategy is not used. With the Te-base material, it should be noted that the approach of securing sufficient cooling time by using the (N/2) recording strategy as in the case of the Sb-base material is not particularly effective. In the case of using the Sb-base material for the recording layer, on the other hand, the process of causing melting, followed by cooling over sufficient time such that the medium temperature is reduced quickly below the temperature in which there occurs crystal growth, is less affected by heating caused by the subsequent pulse trains, and it becomes possible to form an amorphous recording mark of sufficient size while suppressing recrystallization.

In the case of using the material of Te-base, on the other hand, there occurs extensive nucleation when the temperature is reduced after the melting to a temperature below the temperature in which there occurs crystal growth. Thus, in the case the medium is heated under this situation by the optical pulse trains that follow the recording pulse, there tends to be caused crystal growth in the amorphous mark pattern starting from the nuclei thus formed, in view of the small thermal conductivity of the Te-base material. With this, there occurs recrystallization in the amorphous recording mark. In the case of using the “castle pattern” for the writing pulse, the process of re-heating after cooling, which tends to induce nucleation, is eliminated, and the recrystallization of the Te-base material does not proceed easily.

Thus, the effect of inter symbol interference has not been considered when using the drive pattern of the (N/2) recording strategy, which assumes the use of the recording material of Sb-base having large thermal conductivity.

However, in the investigation conducted by the inventor of the present invention and constituting the foundation of the present invention, it was discovered that there arises the problem of increase of jitter caused by inter symbol interference when the space length is reduced, even when the recording material of the Sb-base of large thermal conductivity is used, as in the case of conducting high-speed writing of quadruple speed (4×) mode, for example, in the high-density recording medium such as Blu-ray Disc. This also means that there is a possibility of obtaining excellent recording characteristics even in the quadruple speed (4×) mode of Blu-ray Disc when the inter symbol interference is appropriately compensated for while using the (N/2) recording strategy.

Further, according to the investigation of the inventor of the present invention, it was also discovered that it is preferable to take into consideration not only the space length immediately before a current recording mark but also the space length immediately after the current recording mark when compensating the effect of the inter symbol interference.

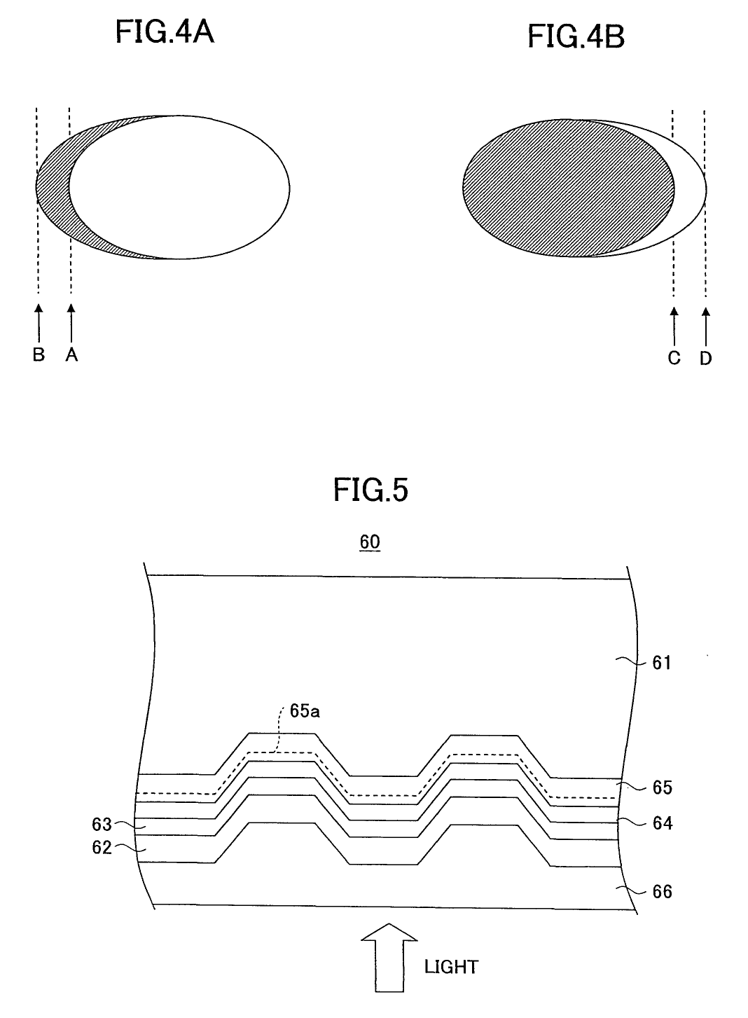

Referring to FIG. 4A, there may be caused excessive increase of temperature when a heating pulse is irradiated for formation a current recording mark when the space length immediately preceding this current recording mark is small because of the residual heat formed at the time of formation of the previous recording mark. When this occurs, the starting location B of the recording mark is displaced from a predetermined leading edge location A of the recording mark.

Further, in the case the space length immediately after the current mark is small, there is caused re-heating at the trailing edge of the recording mark when the next heating pulse is irradiated as shown in FIG. 4B. Thereby, there is caused recrystallization in this part particularly in the case a phase-change material is used for the recording layer, and the trailing edge of the recording mark C is displaced from a predetermined trailing edge location D.

While the foregoing phenomenon appears particularly conspicuously in the 2 T recording marks, better recording characteristics are obtained also for the case of the 3 T recording marks when a similar compensation is applied thereto. While the embodiments described hereinafter are for the case of using the Blu-ray Disc of the storage capacity of 25 GB in which the shortest mark length 2 T is 0.149 μm, the present invention is effective also in the case of the HD DVD of the recording capacity of 15 GB that achieves recording and playback with the shortest mark length of 0.20 μm while using the blue laser diode of the wavelength of 405 nm.

Further, while the effectiveness of the present invention is confirmed for the case of conducting high-speed recording such as quadruple speed (4×) recording mode (linear velocity 19.6 m/s) on a high-density recording medium such as Blu-ray Disc, the present invention is effective also for recording information at high-speed on other rewritable optical information recording media than Blu-ray Disc that use a phase change material for the recording layer such as CD, DVD, HD DVD, and the like.

### EMBODIMENTS OF THE INVENTION

FIG. 5 shows the construction of a rewritable optical information recording medium 60 according to an embodiment of the present invention that uses a phase change material for the recording layer.

Referring to FIG. 5, the optical information recording medium 60 is an optical disc of Blu-ray Disc format including thereon a transparent substrate 61 formed with a guide groove, wherein a first protective layer 62, a phase-change recording layer 63, a second protective layer 64 and a reflection layer 65 are laminated on the substrate 61 with this order when viewed from the side from which a light is irradiated.

In the case of the optical disk of DVD format and HD DVD format, an organic protective film is formed on the reflection layer 65 by a spin coating process, while in the case of a Blu-ray Disc, a transparent cover layer 66 is formed on the first protective layer 42.

While FIG. 5 shows the example in which there is formed only one recording layer, there are proposals of recording media in which there are provided two recording layers with intervening transparent intermediate layer. In this case, the recording layer located at the near side when viewed from the incident side of the light has to be semi-transparent in order to enable recording and play back of the recording layer located at the inner side.

Hereinafter, various parts of the optical information recording medium 60 of FIG. 5 will be explained.

### A. Substrate

First, the substrate 61 will be explained. The substrate 61 may be formed of an ordinary glass, ceramics or resin, wherein it is preferable to form the substrate 61 from resin in view of the easiness of forming process and in view of the cost. For such a resin, it is possible to use polycarbonate resin, acrylic resin, epoxy resin, polystyrene resin, acrylic nitrile-styrene copolymer resin, polyethylene resin, polypropylene resin, silicone resin, fluorine resin, ABS resin, urethane resin, and the like, wherein it is preferable to use a polycarbonate resin or acrylic resin in view of the easiness of forming process, optical properties and cost.

The substrate 61 is formed to have a size, thickness and groove pattern in conformity to the standard of the recording medium 60. In the case of Blu-ray Disc format, the substrate 61 is formed to have a disc shape of the diameter of 12 cm and thickness of 1.1 mm, wherein there are formed guide grooves of the width of 0.14-0.18 μm and depth of 20-35 μm with a track pitch of 0.32 μm. Further, with Blu-ray Disc format, so-called on-groove recording is adopted, in which recording of information is made upon a projection part of the groove when viewed from the side from which the light is irradiated.

Generally, the guide groove is formed with wobble such that the recording apparatus can sample the frequency at the time of recording, wherein it is possible to write address or other information necessary for recording by inverting the phase of the wobble or by changing the frequency in a predetermined region.

Particularly, with the present invention, in which strategy information or information of recording power needed for recording is written in advance to an innermost region (read-in region) of the disk, it becomes possible to carry out the recording with the recording strategy and power condition optimum for the recording speed by reading the strategy information and recording power information by the recording apparatus.

### B. First Protective Layer

Next, explanation will be made on the first protective layer 62 of FIG. 5. Preferably, the first protective layer 62 is formed of an oxide of Si, Zn, Sn, In, Mg, Al, Ti, Zr, or the like, or a nitride of Si, Ge, Al, Ti, B, Zr, or the like, or sulfide of Zn, Ta, or the like, of carbide of Si, Ta, B, W, Ti, Zr, or the like, a diamond-like carbon, or a mixture thereof, wherein it is preferable to use a mixture of ZnS and SiO₂ with a mole ratio in the vicinity of 7:3 to 8:2. Thereby, the first protective layer 62 is formed adjacent to the phase-change recording layer 63 that changes the temperature drastically between room temperature and high temperature, and thus, it is preferable to form the first protective layer 62 to have the composition of (ZnS)₈₀(SiO₂)₂₀ (mole %), wherein it should be noted that this composition provides optimum optical constant, thermal expansion coefficient and elastic modulus. Of course, it is possible to laminate a different material for the first protective layer 62.

The thickness of the first protective layer provides a profound effect on the reflectance, degree of modulation and recording sensitivity of the information recording medium 60. Thus, it becomes possible to increase the recording sensitivity by choosing the film thickness such that the disk reflectance becomes minimum. In the information recording medium 60 of BD-RE format, it is preferable to set the thickness of the first protective layer 62 to 20-50 nm. When the thickness is smaller than the foregoing range, there is caused severe thermal damage to the substrate, leading to the risk that the groove shape may be changed. When the thickness exceeds the foregoing range, the reflectance of the disk becomes excessive, while this leads to degradation of sensitivity.

### C. Phase Change Recording Layer

Next, the phase-change recording layer 63 will be described.

The phase-change recording layer 63 is formed of a material containing Sb as the major component and further added with an element that facilitates formation of amorphous phase, such as the material of the Sb—In system, Sb—Ga system, Sb—Te system, Sb—Sn—Ge system, and the like. Here, “major component” means the element that is contained with a proportion of 50 atomic percent or more. Further, other various elements may be added to the foregoing material for the purpose of improving various characteristics of the recording layer.

In the case of forming the phase-change recording layer 63 by the Sb—In base material, it is preferable to use the following compositional range:

(Sb₁₋ₓInₓ)_{1-y}M_{y},

0.15≦x≦0.27,

0.0≦y≦0.2,

M being one or more elements other than Sb and In.

Even with the material of the Sb—In binary system, excellent repeat recording characteristics are attained. Further, with this material, high crystallization temperature of about 170° C. is attained. Thereby, excellent stability is realized for preserving the amorphous phase state. On the other hand, it is also possible to add, to this material, at least one of the elements of Al, Si, Ti, V, Cr, Mn, Cu, Zn, Ge, Ga, Se, Te, Zr, Mo, Ag and rare earth elements, for the purpose of further improvement of preservation stability of recording, improvement of repeat recording durability, easiness of initialization, and the like. Because addition of these elements tend to invite decrease of crystallization rate, it is also possible to add Sn or Bi for the purpose of improving the crystallization rate. In order to avoid degradation of repeat recording characteristics, it is preferable to suppress the total amount of M to be 20% or less.

In the case of forming the phase-change recording layer 63 by the Sb—Ga base material, it is preferable to use the following compositional range:

(Sb₁₋ₓGaₓ)_{1-y}M_{y},

0.05≦x≦0.2,

0.0≦y≦0.3,

M being one or more elements other than Ga and Sb.

Even with the material of the Sb—Ga binary system, excellent repeat recording characteristics are attained. Further, with this material, high crystallization temperature of about 180° C. is attained. Thereby, excellent stability is realized for preserving the amorphous phase state. On the other hand, increase of the Sb content for increasing the crystallization rate invites the problem that the reflectance after initialization becomes non-uniform. Thus, in order to attain high-speed recording, it is preferable to add an element M improving the non-uniformity of reflectance at the time of initialization. For such an element M, one or more of the elements of Al, Si, Ti, V, Cr, Mn, Cu, Zn, Se, Zr, Mo, Ag, In, Sn, Bi and rare earth elements may be used. Further, because addition of such element M can cause deterioration of stability of the crystalline phase and associated problem that recording can no longer be made with the same condition as before after saving has been made at high temperature as a result of decrease of reflectance caused at the time of high temperature saving, it is further possible to add Ge, Te, or the like, for the element M. On the other hand, in order to avoid degradation of repeat recording characteristics, it is preferable to suppress the total amount of M to be 30% or less.

In the case of forming the phase-change recording layer 63 with a material of the Sb—Te system, it is possible to attain excellent repeat recording characteristics by using the following compositional range.

(Sb₁₋ₓTeₓ)_{1-y}M_{y},

0.2≦x≦0.4,

0.03.0≦y≦0.2,

M being one or more elements other than Sb and Te.

While it is possible to obtain excellent repeat recording characteristics with the Sb-The binary system along, there is a problem, in view of the fact that this binary system has a low crystallization temperature of about 120° C., that the recording mark undergoes crystallization when high temperature saving of information is made. Thus, in the case of forming the recording layer 43 with the material of the Sb—Te system, it is inevitable to add the element M that increases the crystallization temperature and improves the stability of the amorphous phase. For the element M that increases the stability of the amorphous phase, one or more of the elements of Al, Si, Ti, V, Cr, Mn, Cu, Zn, Ga, Ge, Se, Zr, Mo, Ag, In and rare earth elements may be used. Further, in the case such an element is added, there is a tendency of decrease of the crystallization rate. Thus, for the purpose of improving the crystallization rate, it is possible to further add Sn, Bi, or the like. While the additive amount has to be 3 atomic percent or more for attaining the desired effect, it is necessary to suppress the additive amount to be 20 atomic percent or less for avoiding degradation of repeat recording characteristics.

In the case of forming the phase-change recording layer 63 with a material of the Sb—Sn—Ge system, it is possible to attain excellent repeat recording characteristics by using the following compositional range.

(Sb_{1-x-y}GnₓGe_{y})_{1-z}M_{z}

00.1≦x≦0.25,

0.03≦y≦0.30,

0.00≦z≦0.15,

M being one or more elements other than Sb, Sn and Ge.

While it is possible to attain excellent recording characteristics with the ternary material of the Sb—Sn—Ge system, it is possible to decrease the jitter when one or more elements are added further. For the effective element, one or more of Al, Si, Ti, V, Cr, Mn, Cu, Zn, Ga, Ge, Se, Te, Zr, Mo, Ag, In and rare earth elements may be used. When the additive amount is excessive, there is caused deterioration of jitter. Thus, the additive amount is preferably suppressed to 15 atomic percent or less.

In any of the cases of forming the phase-change recording layer 63, the film thickness thereof is set to 6 nm or more. When the film thickness becomes smaller than the foregoing film thickness, there occurs severe degradation in the crystallization rate or modulation degree, and good recording becomes no longer possible. In the case of the information recording medium provided with only one recording layer, the upper limit of film thickness of the recording layer is set to 30 nm or less, more preferably 22 nm or less. This applies also to the inner side recording layer in the case of the information recording medium provided with two recording layers. In the case the information recording medium includes two recording layers, the recording layer at the near side has a film thickness of 10 nm or less, more preferably 3 nm or less. When the film thickness of the recording layer has exceeded the foregoing limit, there is caused decrease of recording sensitivity or degradation of repeat record durability, while in the case of the information recording medium including two recording layers, there arises a difficulty of maintaining the transparent light when the film thickness of the recording layer at the near side has exceeded the foregoing upper limit. Thereby, it becomes difficult to carry out recording or playback with the recording layer located at the far side.

### D. Second Protective Layer

Next, the second protective layer 64 will be described.

Similarly to the first protective layer 42, the second protective layer 44 is formed of an oxide of Si, Zn, Sn, In, Mg, Al, Ti, Zr, and the like, a nitride of Si, Ge, Al, Ti, B, Zr, and the like, a sulfide of Zn, Ta, and the like, a carbide of Si, Ta, B, W, Ti, Zr, and the like, diamond-like carbon, or a mixture thereof.

While the second protective layer provides influence on the reflectance and modulation degree of the information recording medium 60, the effect thereof on the recording sensitivity is the largest, and thus, it is important to use a material of appropriate thermal conductivity coefficient for the second protective layer 64. For example, the mixture of ZnS and SiO₂ of the mole ratio of 7:3 to 8:2 has small thermal conductivity coefficient and use thereof is effective for improving the recording density by way of decreasing the rate of heat dissipation to the reflection layer.

In the case of the information recording medium designed specifically for high-speed recording, there is a case of using a material of large thermal conductivity coefficient for the second protective layer 64. For the material of large thermal conductivity coefficient, it is possible to use a material containing In₂O₃, ZnO or SnO₂ as the major component and used for transparent conductive film or a mixture thereof, or a material containing TiO₂, Al₂O₃ or ZrO₂ as the major component or a mixture thereof, Further, it is possible to laminate different materials.

Preferably, the second protective film 64 is formed to have a film thickness of 4-50 nm. When the film thickness is smaller than 4 nm, optical absorbance of the recording layer 63 is decreased and diffusion of heat formed in the recording layer 63 into the thermal reflection layer is facilitated. Thereby, there occurs extensive degradation of recording sensitivity. On the other hand, when the film thickness exceeds 50 nm, there is a tendency of crack formation.

### E. Reflection Layer

Preferably, the reflection layer 65 is formed of a metal of Al, Au, Ag, Cu, or the like, and an alloy containing the same for the major component. Further, it is possible to add Bi, In, Cr, Ti, Si, Cu, Ag, Pd, Ta, Nd, or the like at the time of alloy formation as additive element.

The reflection layer functions to enhance the utilization efficiency of light by reflection the light at the time of recording or playback and further functions as a heat radiation layer dissipating the heat generated at the time of recording. In the case of the recording medium of the construction in which there is provided only one recording layer, or in the case of making recording to the recording layer of the far side as viewed from the incident side of light in the recording medium of the two-layer structure, it is preferable to provide the reflection layer with the thickness of 70 nm or more from the viewpoint of utilization efficiency of light and securing cooling rate. However, the utilization efficiency of light or cooling rate shows the tendency of saturation when the film thickness has increased beyond a certain film thickness. Further, there is a tendency that the substrate causes warp or there occurs film peeling when the film thickness of the reflection layer is excessive. Thus, it is preferable to set the thickness of the reflection layer 65 to be 300 nm or less.

In the case of the recording medium of the two-layer construction, however, it is not possible to increase the thickness as desired with regard to the reflection layer located at the near side to the incident side of the light, and it is preferable to use the film thickness of 5-15 nm for such a case. In such a construction, however, there can be a case that good recording is not possible because of insufficient heat dissipation characteristics. Thus, a heat radiation layer to be explained below is used.

### F. Cover Layer

The cover layer 66 is the layer through which the light comes in and goes out. In the case of the information recording medium of Blu-ray Disc of single layer construction, a transparent resin layer of the thickness of 100 μm is used for the cover layer 66. In the case of the recording medium of the two-layer construction, the cover layer may be formed by a transparent resin layer of the thickness of 75 μm.

### G. Heat Radiation Layer

In the case of the information recording medium of the two-layer construction (not shown), there is provided a front side phase-change recording layer in front of the phase-change recording layer of the rear side when viewed from the incident side of the light, with an intermediate layer interposed therebetween.

Thereby, the heat radiation layer is provided in the information recording medium of such a two-layer construction between the reflection layer immediately behind the front-side recording layer and the intermediate layer, wherein it is preferable that the heat radiation has large transmittance and large thermal conductivity coefficient, and thus, the heat radiation layer is preferably formed of a material containing In₂O₃, ZnO or SnO₂ for the major component and used for the transparent conductive film or a mixture thereof or a material containing TiO₂, Al₂O₃, ZrO₂, Nb₂O₃, or the like, or a mixture thereof. Depending on the composition of the recording layer, there are cases in which the high efficiency of heat dissipation is not required. In such a case, it is possible to use a mixture of ZnS and SiO₂ used commonly for the protective layer.

Preferably, such a heat radiation layer is formed to have a thickness of 10-150 nm. When the thickness is smaller than 10 nm, the function as the heat radiation layer or the function as the optical adjustment layer becomes insufficient, while when the thickness is excessive, there is a possibility of causing warp in the substrate or peeling of films due to film stress.

### H. Intermediate Layer

As explained before, there is used an intermediate layer in the information recording medium of the two-layer construction (not shown) for separating the front side recording layer from the rear side recording layer when viewed from the incident direction of the light. With the information recording medium of DVD format, the intermediate layer is formed with a transparent resin layer of the thickness of 50 μm, while in the case of the information recording medium of Blu-ray Disc specification or HD DVD specification, a transparent film of the thickness of 25 μm is used.

### I. Anti-Sulfidizing Layer

When using Ag or Ag alloy for the reflection layer 65 and a film containing S, such as a mixture of ZnS and SiO₂, for the second protective layer 64 in the construction of FIG. 5, there is a case in which an anti-sulfidization layer is provided between the second protective layer 64 and the reflection layer 65 for preventing defect formation caused by the sulfidizing of the reflection layer 65.

For the anti-sulfidization layer 65a, it is possible to use any of Si, SiC, TiC, TiO₂ and a mixture of TiC and TiO₂. Such an anti-sulfidization layer has to be formed to have a film thickness of at least 1 nm. When the film thickness is less than 1 nm, no uniform film formation takes place and the function of preventing sulfidization may be lost. Preferably, therefore, the anti-sulfidization layer 64a is formed to have a thickness of 2 nm or more. The upper limit thickness is determined by taking into consideration the balance of optical characteristics and thermal characteristics of the medium. Generally, a better balance is attained when the thickness is set to 10 nm or less. In such a chase, the chance of obtaining excellent repetition recording characteristics is increased.

It should be noted that the foregoing films 62-65 are formed on a substrate 61 subsequently by a sputtering process and is provided for the optical information recording medium after formation of the cover layer 66 and initialization process.

The initialization process is conducted by scanning the surface of the information recording medium with a laser beam having the power of about 1-2 W and shaped to a size of 1×(several ten to several hundred) microns. With this initialization process, the recording layer 43, which takes an amorphous phase in the as-deposition state, undergoes crystallization.

Next, preformatting process of the information recording medium 60 will be explained.

With the information recording medium 60 of the present embodiment, the optical information recording medium is preformatted with the values of the parameters, in addition to the type of the recording strategy such as (N−1) strategy of N/2 strategy, such as the starting time sTtop of the first heating pulse, the termination time eTtop of the first heating pulse, and the like.

Thus, by reading these parameters thus preformatted on the optical recording medium by the information recording apparatus before starting the recording operation, it becomes possible to choose the recording parameters (recording strategy) optimum to any arbitrarily chosen scanning speed v, and set this optimum scanning speed v to the information recording and reproducing apparatus. Further, with the information recording apparatus of the present embodiment, the information of the recording power is also preformatted, and thus, it becomes possible to conduct optimum setting of the recording condition with the information recording apparatus.

For this preformatting process, any arbitrary method can be used, such as pre-pit method, wobble encoding method, formatting method, and the like.

The pre-pit method is the method of preformatting the information regarding recording condition on an arbitrary region of the optical information recording medium while using ROM pits. Because ROM pits are formed at the time of manufacture of the substrate, this approach is suitable for mass production and further has advantageous features of reliability for playback operation and large amount of information. However, the technology of forming the ROM pits (so-called hybrid technology) includes various unsolved problems, and it is though difficult to realize the pre-format technology that uses the pre-pits in the recording media of RW type.

The format method is the method that records the information regarding recording condition on the recording medium with an ordinary recording process. This approach, however, requires preformatting process to each of the optical recording media after manufacturing thereof, and thus, there are various problems when applied to a mass production process. Further, because this approach allows rewriting of the preformat information, the format method is not appropriate for the process of recording information pertinent to a medium.

On the other hand, wobble encoding process has been used in practice in various information recording media format including the format of CD-R/RW, DVD+R/RW and BD-R/RE.

With this approach, the disk-specific information of the optical information recording medium or address information on the disk is encoded on the groove (guide groove on the medium) in the form of wobbling. This encoding process may be conducted by using frequency modulation as in the case of ATIP (absolute time in pregroove) used in CD-R/RW format or using phase modulation as in the case of ADIP (address in pregroove) of DVD+R/RW format.

Because the wobble encoding method forms the disk-specific information at the time of manufacture of the substrate of the optical information recoding medium together with the address information, there is no need of forming special ROM bit as in the case of the prepit method, and it becomes possible to form the substrate easily.

Next, explanation will be made on the information recording apparatus that uses the information recording medium of the present embodiment.

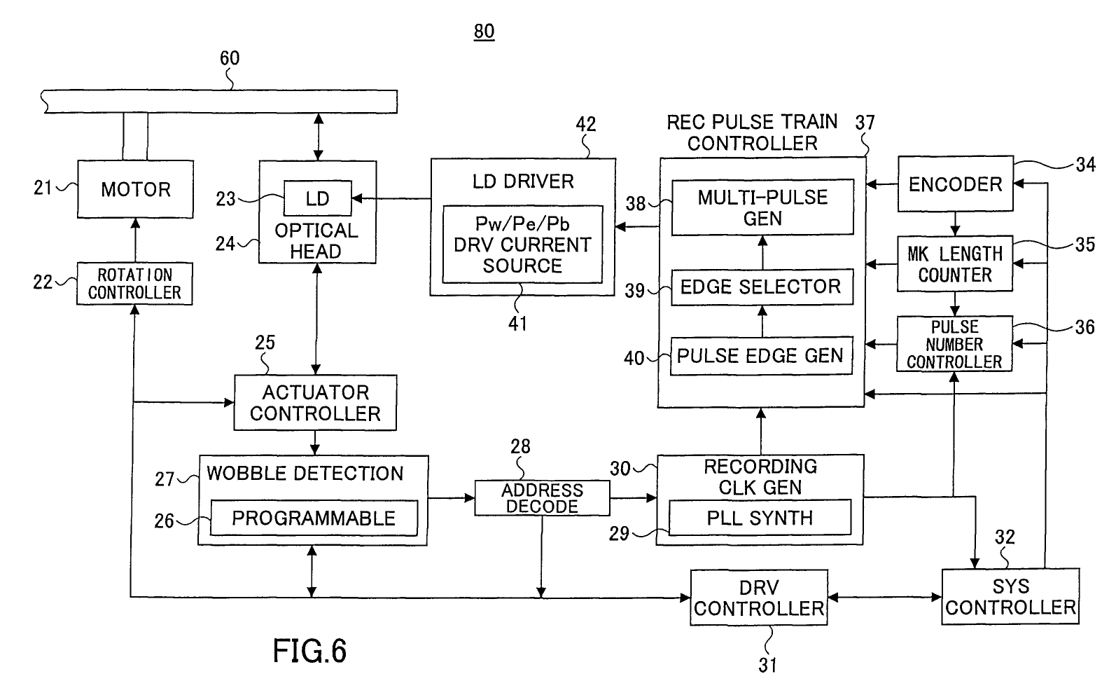

Hereinafter, a information recording apparatus 80 that carries out information recording on the information recording medium 60 according to the recording strategy explained heretofore will be described with reference to FIG. 6.

Referring to FIG. 6, the information recording apparatus 60 includes a rotation control mechanism 22 including therein a spindle motor 21 that drives the optical information recording medium 60 to cause rotation, wherein there is further provided an optical head 24 in a manner movable in a disk radial direction for the purpose of seek operation, wherein the optical head 24 includes therein an objective lens focusing a laser light to the optical recording apparatus 60 and a laser optical source such as a laser diode LD 23. An actuator control mechanism 25 is provided to an objective lens driving apparatus and output system of the optical head 24.

To the actuator control mechanism 25, there is connected a wobble detection part 27 including therein a programmable BPF 27, and an address demodulation circuit 28 is connected to the wobble detection part 27 for demodulating the address from the detected wobble signal. To this address demodulation circuit 28, there is connected a recording clock generation part 30 including therein a PLL synthesizer circuit 29, wherein a drive controller 31 controlled by a system controller 32 is connected to the PLL synthesizer circuit 29.

The drive controller 31 is connected with the rotation control mechanism 22, the actuator control mechanism 25, the wobble detection part 27 and the address demodulation circuit 28.

The system controller 32 is an apparatus of the construction of microcomputer equipped with CPU and an encoder 34, a mark length counter 35 and a pulse number control part 36 are connected to the system controller 32. To the encoder 34, the mark length counter 35, the pulse number controller 36 and the system controller 32, there is connected a recording pulse train control part 37 that functions as an optical emission waveform control means, wherein the recording pulse train control part 37 includes therein a multiple-pulse generator 38 generating multiple pulses in the form of a pulse train of a heating pulse and a cooling pulse prescribed by the recording strategy, an edge selector 39 and a pulse edge generation part 40.

At the output side of the recording pulse train controller 37, there is connected a LD driver part 42 functioning as optical source driving means, wherein the LD driver part 42 drives the laser diode 23 in the optical head 24 to causing switching in a driving current source 41 between the recording power Pw, the erasing power Pe and the biasing power Pb.

When conducting recording of information to the optical information recording medium 60 with such a construction, the rotational speed of the spindle motor 21 is controlled by the rotation control mechanism 22 under control of the drive controller 31, such that a line speed corresponding to a target recording speed is attained. After the line speed is controlled as such, the address is demodulated by detection of the wobble signal separated by the programmable BPF 26 from a push-pull signal obtained by the optical head 24. Further, a recording channel clock is generated by the PLL synthesizer circuit 29.

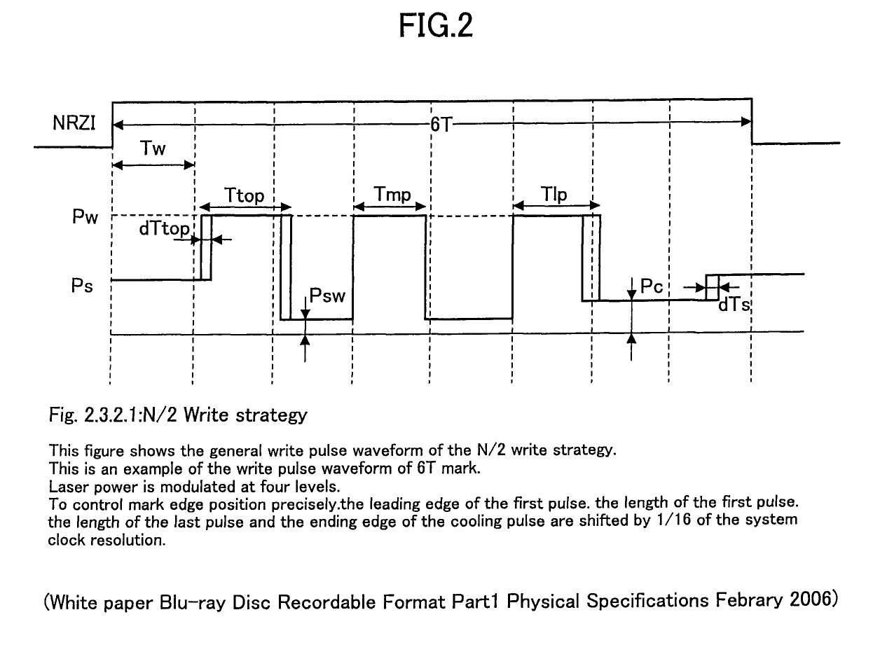

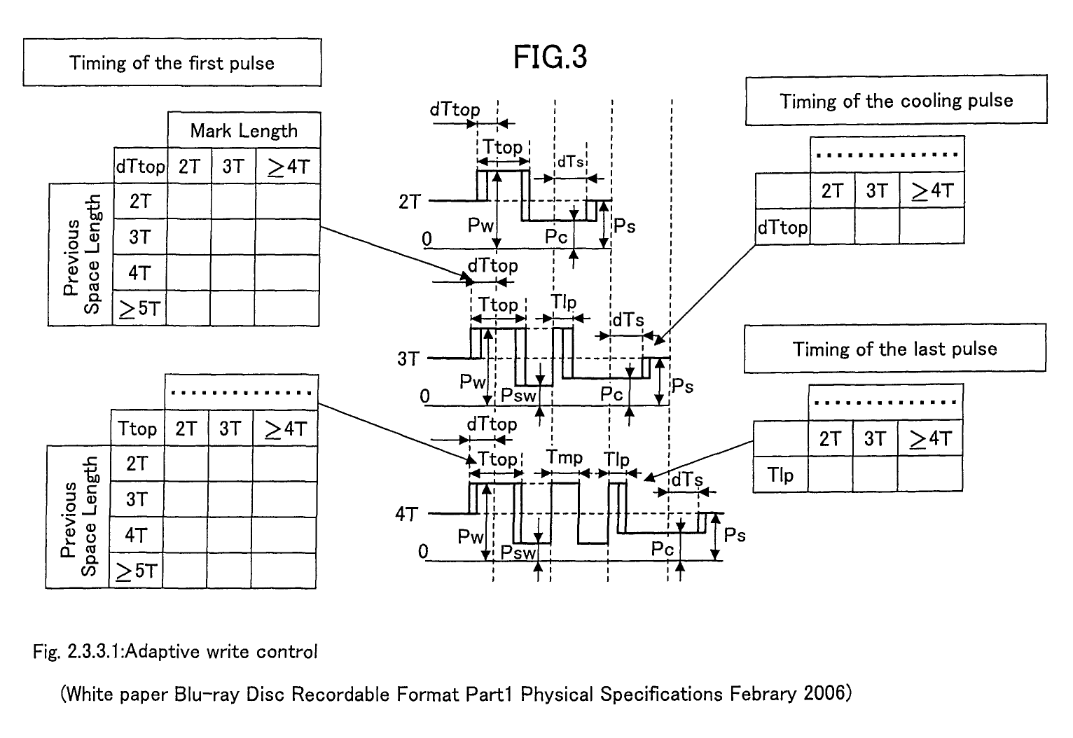

Next, in order to generate the recording pulse train with the laser diode LD 23, 17PP data constituting the recording channel clock and recording information is supplied to the recording pulse train controller 37, and the multiple pulses are generated by the multiple pulse generation part 38 in the recording pulse train controller 37 according to the recording strategy shown in FIG. 2. Thereby, the LD driver part 42 causes switching of the drive current source 41 to one of the foregoing power levels of Pw, Pe and Pb, and with this, it becomes possible to obtain LD emission waveform corresponding to the recording pulse train.

Further, with the recording pulse train control part 27 of the construction of the present embodiment, there is provided a mark length counter 35 for counting the mark length of the 17PP signal obtained from the encoder 34, and the multiple pulses are generated by way of the pulse number control part 36 such that a set of heating pulse and a cooling pulse are generated each time the mark count value increases by 2 T.

As an alternative construction of the multiple pulse generation part, it is also possible to use a construction, in which a frequency-divided recording clock is generated by dividing the frequency of the recording channel clock to one-half frequency, edge pulses are formed by using a multiple delay circuit, and front edge and rear edge are selected by using an edge selector, such that a pair of heating pulse and a cooling pulse are formed each time the recording channel clock increased by 2 T.

### Example 1

In Example 1, the inventor of the present invention has manufactured a specimen of the information recording medium 60 by using a polycarbonate disk substrate of the BD-RE format transcribed with a continuous groove of spiral form for the substrate 61 and further forming the reflection layer 65, the second protective layer 64, the phase-change recording layer 63, the first protective layer 62, and the cover layer 66 consecutively thereon, and further conducting an initial crystallization process for causing crystallization in the recording layer.

For the reflection layer 65, an Ag-0.5 wt % Bi alloy layer of the thickness of 140 nm is used. For the second protective layer 64, a ZnO-2 wt % Al₂O₃ layer of the thickness of 8 nm is used. For the phase-change recording layer 63, an In₁₈Sb₇₇Zn (atomic percent) layer of the thickness of 11 nm is used. For the first protective layer 62, a ZnS-20 mol % SiO₂ layer is formed with the thickness of 33 nm. The film formation was made by using a sputtering apparatus DVD sprinter (model name) marketed from Unaxis.

Further, an adhesive of a UV-cure resin is applied on the laminated structure thus obtained by a spin-coating process, and the cover layer 66 is formed by bonding a polycarbonate film marketed from Teijin with the thickness of 0.75 μm.

Next, the recording layer is subjected to initial crystallization process by using a large diameter laser.

Further, record of information is made upon the specimen thus obtained while using a BD-R/RE record/playback signal evaluation apparatus ODU-1000 of Pulsetec Industrial Co. Thereby, an optical pickup designed for the wavelength of 405 nm and having a numerical aperture (NA) of 0.85 is used.

The experiment is conducted by setting the scanning speed to 19.68 m/s, which corresponds to a quadruple speed (4×) mode of the Blu-ray Dick of 25 GB, and further setting the channel clock (fundamental clock period) to 106.68 MHz corresponding to the quadruple speed (4×) mode. The shortest mark length 2T for this case corresponds to the physical length of 0.149 μm. In the experiment, a random pattern based on the 1-7PP, which is the modulation scheme used with the technology of Blu-ray Disc is recorded as the recording information.

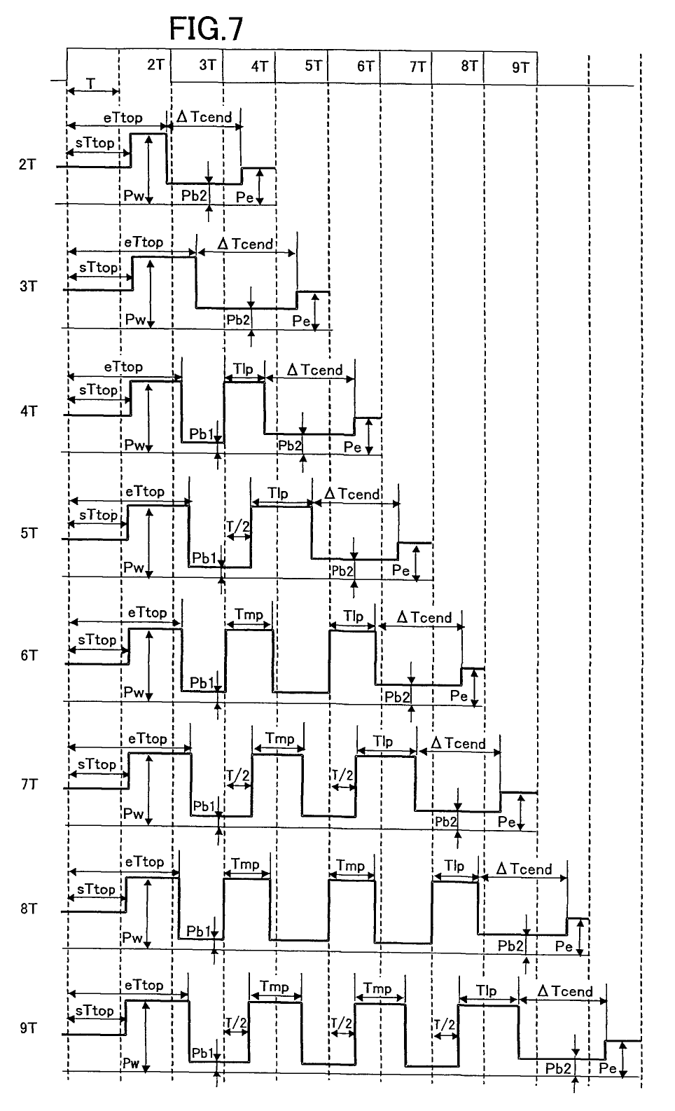

FIG. 7 shows the definition of various parameters used for defining the N/2 recording strategy.

Referring to FIG. 7, Pw represents the recording mark formation power level, Pb1 and Pb2 represent the optical pulse power level used during the interval where medium cooling takes place subsequent to the recording mark formation, and Pe represents the optical power level for space formation. Further, sTop represents the starting time of the first heating pulse, while eTtop represents the termination time of the first heating pulse. Further, Tlp represents the duration of heating at the time of formation of the last recording mark, while Tmp represents the duration of heating at the time of formation of the intermediate recording mark. ΔTcend represents the time interval from termination of the last recording mark formation pulse to the start of the optical pulse used for the space formation.

In Example 1, the values summarized in Table 1 are used for the parameters of FIG. 7.

TABLE 1

| | | Space when | |
|---|---|---|---|
| | | inter-symbol | |
| | | interference is | |
| Parameter | Current mark | considered | value |
| Tmp | Mark length = | | 1.00 |
| | 6T-9T | | |
| sTtop | Mark length ≧ | | 1.00 |
| | 4T | | |
| | Mark length = | | 0.725 |
| | 3T | | |
| | Mark length = | Pre-space | 0.950 |
| | 2T | length ≧ 5T | |
| | ↑ | Pre-space | 0.950 |
| | | length = 4T | |
| | ↑ | Pre-space | 0.975 |
| | | length = 3T | |
| | ↑ | Pre-space | 0.975 |
| | | length = 2T | |
| eTtop | Mark length = | — | 2.10 |
| | 5T, 7T, 9T | | |
| | Mark length = | — | 2.00 |
| | 4T, 6T, 8T | | |
| | Mark length = | — | 2.50 |
| | 3T | | |
| | Mark length = | — | 1.65 |
| | 2T | | |
| Tlp | Mark length = | | 1.00 |
| | 5T, 7T, 9T | | |
| | Mark length = | | 0.70 |
| | 4T, 6T, 8T | | |
| ΔTcend | Mark length = | | 0.0 |
| | 5T, 7T, 9T | | |
| | Mark length = | | 0.0 |
| | 4T, 6T, 8T | | |
| | Mark length = | | 0.0 |
| | 3T | | |
| | Mark length = | | 0.0 |
| | 2T | | |

Referring to Table 1, it should be noted that, with the present embodiment, the parameter sTtop representing the starting time of the first heating pulse is set independently for the cases in which the space length immediately before the 2 T mark (pre-space length) is 2 T, 3 T, 4 T, and 5 T or more.

Further, recording is made repeatedly ten times on the same five continuous tracks under this condition and the track at the center is played back with the 1×speed (4.92 m/s). Further, measurement of jitter is made after limit equalization.

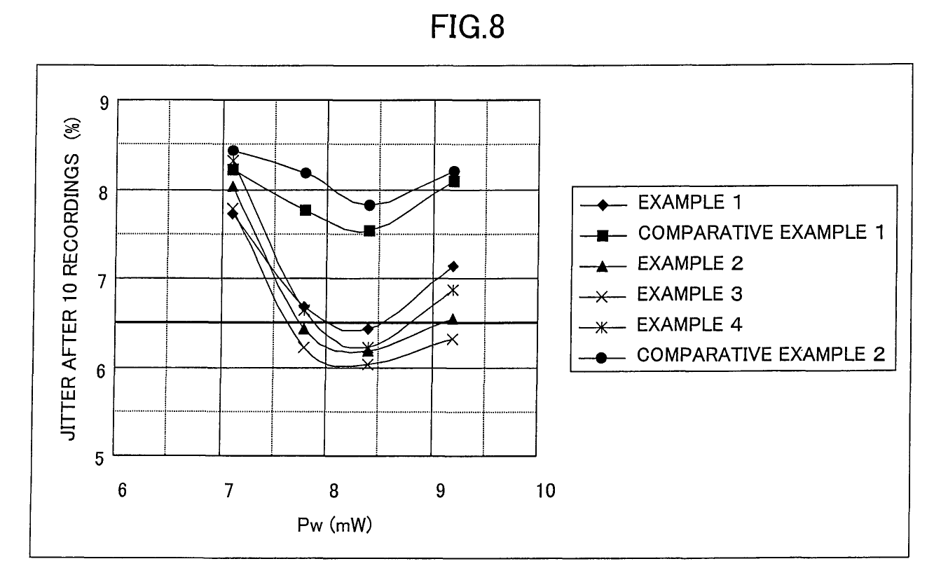

FIG. 8 shows the dependence of jitter on the recording mark formation power level Pw (“Example 1”). In FIG. 8, it should be noted that the vertical axis represents the measured jitter after repeating the recording mark formation for ten times, while the horizontal axis represents the recording power Pw.

Referring to FIG. 8, the power level Pe for space formation is set such that the ratio E thereof to the recording mark power level Pw (ε=Pe/Pw), takes the value of 0.25. With regard to the cooling pulse power level Pb, the power level Pb1 and the power level Pb2 may be set to different values as shown in FIG. 7, while with Example 1, the power levels Pb1 and Pb2 are set equal (Pb1=Pb2) so as to take a common value of 0.1 mW, irrespective of the value of the recoding mark formation power level Pw.

Further, FIG. 8 shows, as “Comparative Example 1”, the jitter for the case of using the same recording strategy, which is used when the space length immediately before the recording mark (pre-space length) is 5 T or more, also for the case of the current recording mark of the mark length 2 T irrespective of the space length immediately before the current recording mark (Comparative Example 1).

Referring to FIG. 8, it can be seen that a satisfactory jitter of 6.4% is attained with Example 1 for the case of using the recording mark formation power Pw of 8.4 mW, while in the case of Comparative Example 1, a jitter of 7.5% is obtained. This value, however, is higher by 1% as compared with the case of Example 1. Because it is specified that jitter has to be 6.5% or less in Blu-ray Disc in the measurement conducted with similar evaluation process, it is concluded that Comparative Example 1 cannot satisfy this specification. Further, it can be seen that, with Example 1, there is a possibility of satisfying this specification even when in the quadruple speed (4×) recording mode when the N/2 recording strategy is used and by choosing the value of sTtop individually for the cases in which the space length immediately before the current 2 T mark (pre-space length) is 2 T, 3 T, 4 T, and 5 T or more.

### Example 2

With Example 2, evaluation similar to the case of Example 1 is carried out on the same medium used in Example 1 while using the parameters of recording strategy as shown in Table 2 below.

TABLE 2

| | | Space when | |
|---|---|---|---|
| | | inter-symbol | |
| | | interference is | |
| Parameter | Current mark | considered | value |
| Tmp | Mark length = | | 1.00 |
| | 6T-9T | | |
| sTtop | Mark length ≧ | | 1.00 |
| | 4T | | |
| | Mark length = | | 0.725 |
| | 3T | | |
| | Mark length = | Pre-space | 0.950 |
| | 2T | length ≧ 5T | |
| | ↑ | Pre-space | 0.950 |
| | | length = 4T | |
| | ↑ | Pre-space | 0.975 |
| | | length = 3T | |
| | ↑ | Pre-space | 0.975 |
| | | length = 2T | |
| eTtop | Mark length = | — | 2.10 |
| | 5T, 7T, 9T | | |
| | Mark length = | — | 2.00 |
| | 4T, 6T, 8T | | |
| | Mark length = | — | 2.50 |
| | 3T | | |
| | Mark length = | Post-space | 1.65 |
| | 2T | length ≧ 5T | |
| | ↑ | Post-space | 1.70 |
| | | length = 4T | |
| | ↑ | Post-space | 1.70 |
| | | length = 3T | |
| | ↑ | Post-space | 1.70 |
| | | length = 2T | |
| Tlp | Mark length = | — | 1.00 |
| | 5T, 7T, 9T | | |
| | Mark length = | — | 0.70 |
| | 4T, 6T, 8T | | |
| ΔTcend | Mark length = | — | 0.0 |
| | 5T, 7T, 9T | | |
| | Mark length = | — | 0.0 |
| | 4T, 6T, 8T | | |
| | Mark length = | — | 0.0 |
| | 3T | | |
| | Mark length = | — | 0.0 |
| | 2T | | |

Thus, N/2 recording strategy is used for the recording strategy and the value of the parameter sTtop indicating the starting time of the first heating pulse is set individually for each of the cases in which the space length immediately before the current 2 T mark (pre-space length) is 2 T, 3 T, 4 T, and 5 T or more. Further, the value of the parameter eTtop indicating the termination time of the first heating pulse is set individually for each of the cases in which the space length immediately after the current 2 T mark (post-space length) is 2 T, 3 T, 4 T, and 5 T or more.

FIG. 8 shows the jitter for the case of Example 2.

Referring to FIG. 8, generally low jitter value is obtained with Example 2 as compared with Example 1, indicating that the recording margin of the quadruple speed (4×) recording mode is expanded.

### Example 3

With Example 3, evaluation experiment similar to the case of Example 1 is carried out on the same medium used in Example 1 while using the parameters of recording strategy as shown in Table 3 below.

TABLE 3

| | | Space when | |
|---|---|---|---|
| | | inter-symbol | |
| | | interference is | |
| Parameter | Current mark | considered | value |
| Tmp | Mark length = | — | 1.00 |
| | 6T-9T | | |
| sTtop | Mark length ≧ | — | 1.00 |
| | 4T | | |
| | Mark length = | Pre-space | 0.725 |
| | 3T | length ≧5T | |
| | ↑ | Pre-space | 0.725 |
| | | length = 4T | |
| | ↑ | Pre-space | 0.725 |
| | | length = 3T | |
| | ↑ | Pre-space | 0.875 |
| | | length = 2T | |
| | Mark length = | Pre-space | 0.950 |
| | 2T | length ≧ 5T | |
| | ↑ | Pre-space | 0.950 |
| | | length = 4T | |
| | ↑ | Pre-space | 0.975 |
| | | length = 3T | |
| | ↑ | Pre-space | 0.975 |
| | | length = 2T | |
| eTtop | Mark length = | — | 2.10 |
| | 5T, 7T, 9T | | |
| | Mark length = | — | 2.00 |
| | 4T, 6T, 8T | | |
| | Mark length = | Post-space | 1.80 |
| | 3T | length ≧ 5T | |
| | ↑ | Post space | 1.80 |
| | | length = 4T | |
| | ↑ | Post space | 1.80 |
| | | length = 3T | |
| | ↑ | Post space | 1.80 |
| | | length = 2T | |
| | Mark length = | Post-space | 1.65 |
| | 2T | length ≧ 5T | |
| | ↑ | Post-space | 1.70 |
| | | length = 4T | |
| | ↑ | Post-space | 1.70 |
| | | length = 3T | |
| | ↑ | Post-space | 1.70 |
| | | length = 2T | |
| Tlp | Mark length = | — | 1.00 |
| | 5T, 7T, 9T | | |
| | Mark length = | — | 0.70 |
| | 4T, 6T, 8T | | |
| ΔTcend | Mark length = | — | 0.0 |
| | 5T, 7T, 9T | | |
| | Mark length = | — | 0.0 |
| | 4T, 6T, 8T | | |
| | Mark length = | — | 0.0 |
| | 3T | | |
| | Mark length = | — | 0.0 |
| | 2T | | |

With the present example, N/2 recording strategy is used for the recording strategy and the value of the parameter sTtop indicating the starting time of the first heating pulse is set individually for each of the cases in which the space length immediately before the current mark (pre-space length) is 2 T, 3 T, 4 T, and 5 T or more for the case the current mark is a 2 T mark similarly to Examples 1 and 2 and also for the case in which the current mark is a 3 T mark. Further, the value of the parameter eTtop indicating the termination time of the first heating pulse is set individually for each of the cases in which the space length immediately after the current mark (post-space length) is 2 T, 3 T, 4 T, and 5 T or more for the case the current mark is a 2 T mark similarly to Examples 1 and 2 and also for the case in which the current mark is a 3 T mark. Thereby, the values of the parameters sTtop and eTtop are optimized with Example 3 for attaining small jitter value. It turned out that the parameter eTop for the 3 T mark takes the same value for any of the cases in which the space length after the current mark (post-space length) is 2 T, 3 T, 4 T, and 5 T or more.

FIG. 8 shows the jitter after conducting repeated recording for ten times. It can be seen that, with Example 3, a generally small jitter value is obtained with Example 3 as compared with Examples 1 and 2, indicating that the recording margin of the quadruple speed (4×) mode is expanded further.

Further, the inventor of the present invention had made investigation for the preferable range for the changing amount of the parameters sTtop and eTtop in correspondence to the case of changing the value thereof in accordance with the space length before and after the current mark (pre- and post-space lengths).

As a result, it was discovered for the case of the current mark of 2 T or 3 T, that the effect of reducing jitter is not obtained effectively when value of the parameter sTtop and eTtop is changed for the case of the space length of 2 T, 3 T or 4 T with regard to the case in which there is a space length of 5 T or more before or after the current mark (pre- and post-space length), unless the value of the parameters sTtop or eTtop is changed with the amount of at least 0.02 T, preferably 0.025 T.

It is believed that this reflects the situation in that there is caused little substantial change in the optical emission wavelength when the amount of change is smaller than 0.02 T and no effect is attained.

With regard to the maximum value of the foregoing changing amount, it can be seen from Table 3 that the value for the parameter sTtop for the case the current mark has the mark length 3 T and the space length immediately before is 2 T (pre-space length) takes the maximum value. In this case, it can be seen that the value of the parameter sTtop is changed by 0.15 T as compared with the case of the space length immediately before the current mark (pre-space length) is 5 T. When this changing value is increased further, it is shown that good jitter is obtained until 0.2 T. On the other hand, when the changing amount is increased further, it is shown that jitter is deteriorated. Thus, it is concluded that, when the value of sTtop and eTtop is changed depending on the space length before and after the current mark (pre- and post-space lengths), it is preferable to change the value within the range of 0.02 T-0.2 T, more preferably within the range of 0.0.25 T-0.2 T.

### Example 4

In Example 4, evaluation of recording characteristics is made similarly to Examples 1-3 for the information recording medium 60 of FIG. 5 having the layer structure identical to that of Example 1 except that a layer of the composition of Ge₁₃Sn_{67.5}Sn_{1.5}Mn_{4.5} (atomic percent) is used for the recording layer 63. For the recording strategy, the parameters shown in Table 3 are used.

FIG. 8 shows the result of Example 4.

Referring to FIG. 8, it can be seen that excellent recording characteristics similar to the case of Examples 1-3 are attained also for the case in which the recording layer 63 has a different composition.

Further, evaluation is made for the case the values of sTtop and eTtop, used for the case the space length is 5 T or more, is used also for the 2 T and 3 T marks irrespective of the space length immediately before and after the current mark (pre- and post-space lengths) as Comparative Example 2 as shown in FIG. 8.

Referring to FIG. 8, it can be seen that there occurs increase of jitter when the space length before and after the current mark (pre- and post-space lengths) is not taken into consideration also in the case of Comparative Example 2 that uses a different recording layer, similarly to the case of Comparative Example 1.

### Example 5

In Example 5, experiment is conducted on the same recording medium used in Example 1 while using the channel clock of 106.68 MHz, which is identical to the case of Example 1, except that the reference line speed is increased from 4.55 m/s to 8 m/s, in correspondence to the quadruple speed (4×) mode.

In this case, the mark length becomes shorter when the reference line speed is decreased and longer when the reference line speed is increased, wherein the shortest mark length changes between 0.138 μm and 0.242 μm in the case of Example 5. Further, with example 5, the parameters shown in Table 2 is used for the recording strategy and the parameters sTtop and eTtop are determined while taking into consideration the space length before and after the 2 T mark.

Further, for the purpose of comparison, experiment is conducted as Comparative Example 3, in which the values of the parameters sTtop and eTtop for the case there is a space length of 5 T or more immediately before and after the current mark (pre- and post-mark lengths), are used for the current mark of 2 T irrespective of the space length before and after the current mark (pre- and post-space lengths).

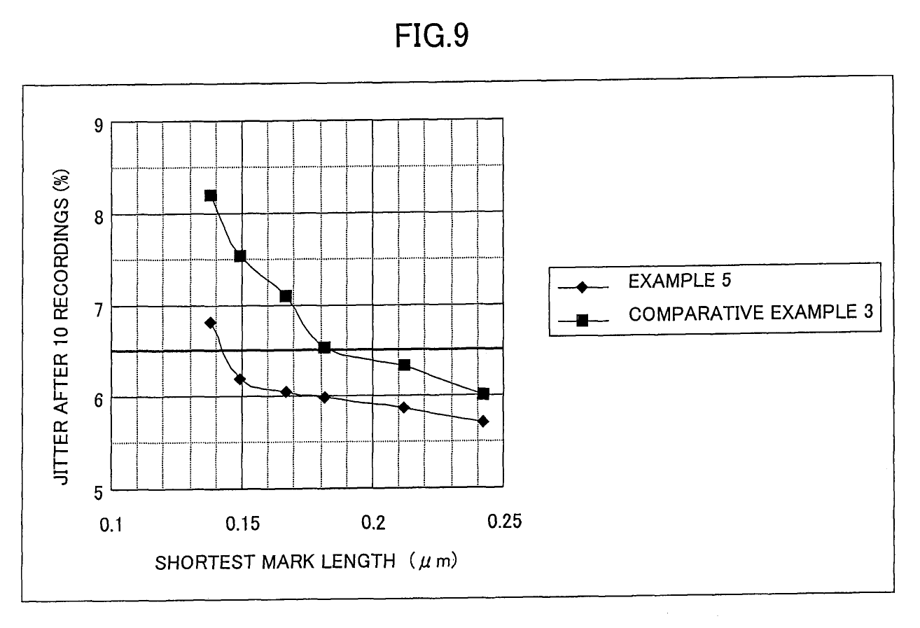

FIG. 9 shows the relationship between the smallest jitter value thus obtained an the shortest mark length. In FIG. 9, it should be noted that the recording power, and the like, are optimized.

Referring to FIG. 9, it can be seen that a lower jitter is attained with the case of Example 5 as compared with the case of Comparative Example 3 for the all the mark lengths.

From FIG. 9, it can be seen that good characteristics are attained for the recording marks of long mark lengths even when the parameters sTtop and eTtop are not changed I response to the space lengths before and after the current mark (pre- and post-space lengths). In the case the shortest mark length is longer than about 0.2 μm, for example, it can be seen that standard value of jitter of 6.5% prescribed for a Blu-ray Disc is attained even in the case of Comparative Example 3 that uses the value of the parameters sTtop and eTtop for the case where the space length before and after the current mark (pre- and post-space lengths) is 5 T or more, provided that the shortest mark length is longer than about 0.2 μm. Thus, it is concluded that, in the case the shortest mark length is longer than 0.2 μm, it is not absolutely necessary to determine the values for the parameters sTtop and eTtop while taking into consideration the space length before and after the current mark (pre- and post-space lengths).

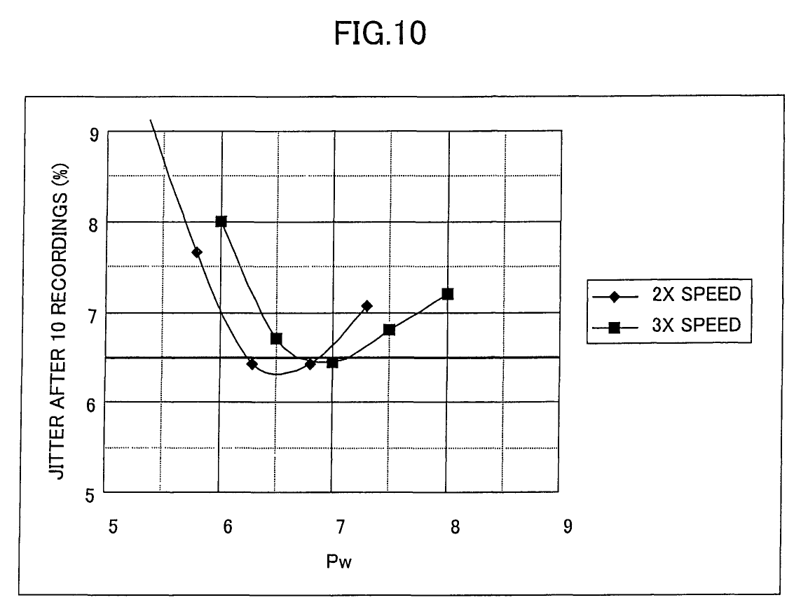

FIG. 10 further shows Reference Example 4, in which recording is made upon the same medium used in Example 1 with triple speed (3×) and double speed (2×) mode with the reference line speed 4.92 m/s while decreasing the recording line speed and channel clock rate. In FIG. 10, it should be noted that the vertical axis represents the measured jitter after repeating the recording mark formation for ten times, while the horizontal axis represents the recording power Pw similarly to FIGS. 8 and 9.

With the recording strategy of Reference Example 4, N/2 recording strategy is used throughout and no optimization is made for the parameters sTtop and eTtop with regard to the space length before and after the current mark (pre- and post-space lengths)-Further, the recording medium used with the conventional specification of 1-2× speed mode Blu-ray Disc format is used.

Referring to FIG. 10, it can be seen that good recording characteristics are attained with regard to writing made with double or triple speed, even when the space length before and after the current 2 T mark is not taken into consideration.

The present invention is based on Japanese priority applications No. 2006-250050 and No. 2007-154295, respectively filed on Sep. 14, 2006 and Jun. 11, 2007, which are incorporated herein as reference.

1. An information recording method recording information on an information recording medium in the form of a recording mark having a time-length of nT (T: fundamental clock period, n being a natural number of 2 or larger) by irradiating optical beam pulses thereto according to a recording strategy, said recording strategy comprising the steps of:
forming said recording mark on said recording medium by controlling a power of said optical beam pulses to one of at least ternary values Pw, Pb and Pe (Pw>Pe>Pb) and irradiating a heating pulse, in which said power of said optical beam pulse is set to said power Pw, and a cooling pulse, in which said power of said optical beam pulse is set to said power Pb, upon said information recording medium alternately; and
forming a space on said recording medium subsequent to said recording mark by irradiating said optical beam pulse with said power Pe, said recording strategy increasing the number of said heating pulses by one each time said time-length of said recording mark is increased by 2 T, said recording strategy setting a heat pulse starting time sTtop for a first heating pulse and a heat pulse termination time eTtop for said first heating pulse, when forming a recording mark of a time-length of at least 2 T, individually at least in the case of forming a space-length of 2 T and the case in which there is formed a space-length of 3 T or more, before or after said currently formed recording mark.

2. The information recording method as claimed in claim 1, wherein a shortest recording mark formed on said information recording medium has a length of 0.20 μm or less.

3. The information recording method as claimed in claim 1, wherein formation of said recording mark on said information recording medium is conducted with a linear recording speed larger than a reference linear speed by four times or more.

4. The recording method as claimed in claim 1, wherein said starting time STtop and termination time eTtop for said first heating pulse are pre-formatted upon said information recording medium, and wherein setting of said starting time sTtop and termination time eTtop of said first heating pulse is executed by reading out said starting time sTtop and termination time eTtop of said first heating pulse pre-formatted on said recording medium.

5. An information recording medium for recording with information, when irradiated with optical beam pulses, in the form of a recording mark having a time-length of nT (T: fundamental clock period, n being a natural number of 2 or more),
said information recording medium being pre-formatted according to a recording strategy in which recording is made by controlling a power of said optical beam pulses to one of at least ternary values of Pw, Pb and Pe (Pw>Pe>Pb) and irradiating a heating pulse, in which said power of said optical beam pulse is set to said power Pw, and a cooling pulse, in which said power of said optical beam pulse is set to said power Pb, upon said information recording medium alternately; and forming a space on said recording medium subsequent to said recording mark by irradiating said optical beam pulse with said power Pe, said recording strategy increasing the number of said heating pulses by one each time said time-length of said recording mark is increased by 2 T, said recording strategy being used when forming a recording mark of a time-length of at least 2 T and setting a heat pulse starting time sTtop for a first heating pulse and a heat pulse termination time eTtop for said first heating pulse individually at least in the case of forming a space-length of 2 T and the case in which there is formed a space-length of 3 T or more, before or after said currently formed recording mark.

6. The information recording medium as claimed in claim 5, wherein said first and second parameters are recorded on said information recording medium together with address information by way of wobble encoding.

7. The information recording medium as claimed in claim 5, wherein said information recording medium comprises a substrate and a recording layer formed on said substrate and containing Sb, said recording mark being formed in said recording layer.

8. An information recording apparatus for recording information on an information recording medium by irradiating thereto optical beam pulses in the form of a recording mark having a time-length of nT (T: fundamental clock period, n being a natural number of 2 or more), said information recording apparatus comprising:
an optical source for forming said optical beam pulses; a driving system for driving said optical source; and
an optical emission controlling apparatus set with a recording strategy determining optical emission waveform, said optical emission controlling apparatus controlling said driving system according to said recording strategy,
said recording strategy forming said recording mark on said recording medium by controlling a power of said optical beam pulses to one of at least ternary values Pw, Pb and Pe (Pw>Pe>Pb) and irradiating a heating pulse, in which said power of said optical beam pulse is set to said power Pw, and a cooling pulse, in which said power of said optical beam pulse is set to said power Pb, upon said information recording medium alternately; and
forming a space on said recording medium subsequent to said recording mark by irradiating said optical beam pulse with said power Pe, said recording strategy increasing the number of said heating pulse by one each time said time-length of said recording mark is increased by 2 T,
said recording strategy setting a heat pulse starting time sTtop for a first heating pulse and a heat pulse termination time eTtop for said first heating pulse, when forming a recording mark of a time-length of at least 2 T, individually at least in the case of forming a space-length of 2 T and the case in which there is formed a space-length of 3 T or more, before or after said currently formed recording mark.
